(19) United States
(12) Patent Application Publication
(10) Pub. No.: US 2008/0315575 A1
(43) Pub. Date: Dec. 25, 2008

(54) Tubular Joint

(76) Inventors: Jean-Pierre Vitel, Thiaucourt-Regnieville (FR); Daniel Grojean, Gondreville (FR); Philippe Renard, Fleville (FR)

Correspondence Address: SUGHRUE MION, PLLC, 2100 PENNSYLVANIA AVENUE, N.W., SUITE 800, WASHINGTON, DC, 20037, US

(21) Appl. No.: 12/161,599

(22) PCT Filed: Jan. 18, 2007
(86) PCT No.: PCT/FR2007/000093

§ 371 Date: Aug. 6, 2008

(30) Foreign Application Priority Data
Jan. 23, 2006 (FR) 06 00597

(51) Int. Cl. F16L 21/08

(52) U.S. Cl. 285/80

(57) ABSTRACT

The invention concerns a tubular joint comprising an interlocking tip (4) provided with an inner groove (18) for receiving a smooth tip (6) and a sealing liner (8) arranged in the inner groove (18). It also comprises anti-extrusion means (10) adjacent the sealing liner (8) for countering an extrusion of the sealing liner (8) when the latter is subjected to the pressure of a fluid circulating in the tubular joint. The invention is applicable to drinking water distribution pipes.

The present invention relates to a tubular joint, of the type comprising:
an interlocking tip of a first pipe element equipped with an inner groove and suitable to receive a smooth tip of a second pipe element, and,
a sealing liner arranged in the inner groove,
   the tubular joint comprising anti-extrusion means adjacent to the sealing liner and suitable for opposing extrusion of the sealing liner when said liner is subjected to the pressure of a fluid circulating in the pipe elements.

It applies in particular to pipes transporting drinking water or waste water for sewerage.

Such tubular joints are known in the state of the art. When the tubular joint is fitted, and when a fluid under pressure is circulating in the pipe elements, there is a risk that the sealing liner may be extruded, or even expelled between the interlocking tip and the smooth tip under the action of the fluid under pressure.

Consequently, the known tubular joint has limited reliability.

The invention therefore relates to increasing the reliability of a tubular joint of the type indicated.

Accordingly, the invention relates to a tubular joint of the type indicated, characterised in that it comprises at least one locking element arranged adjacent to anti-extrusion means, on the side opposite the sealing liner.

According to particular embodiments, the tubular joint comprises one or more of the following characteristics:
the anti-extrusion means comprise an anti-extrusion ring;
the anti-extrusion ring is open and comprises two end portions which, when fitted in the inner groove, overlap at the circumference;
the anti-extrusion ring is fixed to the sealing liner;
the anti-extrusion ring is applied freely on the sealing liner;
the anti-extrusion means comprise at least two anti-extrusion elements in the form of a ring segment;
the anti-extrusion elements are integral with the anti-extrusion ring;
at least one locking element is fixed to the anti-extrusion ring;
at least one of the locking elements is fixed releasably to the anti-extrusion ring;
the locking element is fixed by complementarity of form, in particular by latching, to the anti-extrusion ring;
the or each locking element is inserted in an interstice formed by the anti-extrusion elements, and the outer surfaces of at least one locking element and at least one of the anti-extrusion elements are made flush;
the anti-extrusion ring comprises thrust means suitable for stressing the or each locking element axially away from the sealing liner;
the thrust means comprise a thrust projection integral with the anti-extrusion ring;
the sealing liner comprises thrust means, in particular a flexible lip integral with the sealing liner, suitable for stressing the or each locking element axially away from the sealing liner;
the thrust means have a free end turned radially outwards or inwards; and
the tubular joint comprises a smooth tip inserted in the interlocking tip, the sealing liner being compressed radially between the smooth tip and the interlocking tip.

The invention will be better understood on reading the description that follows, given solely as an example and with reference to the accompanying drawings, in which:

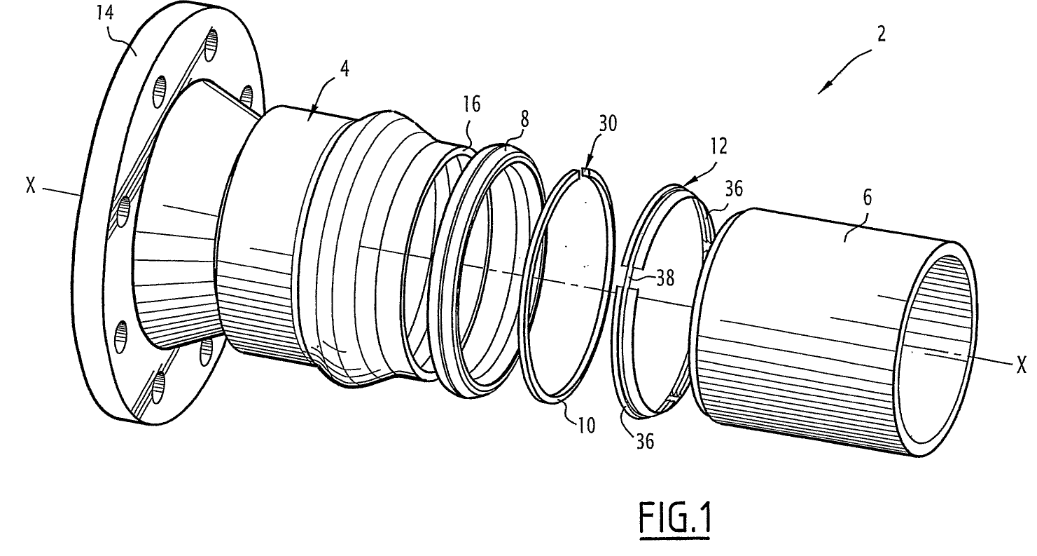

FIG. 1 is a perspective view of a tubular joint according to the invention in the unassembled state;

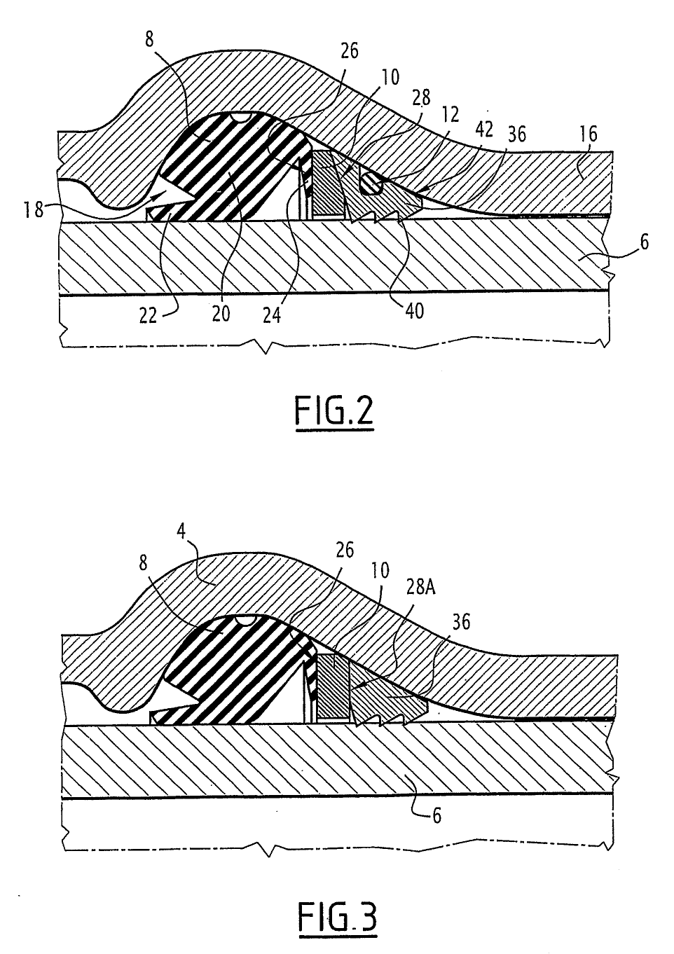

FIG. 2 is a longitudinal cross-section of a portion of the tubular joint of FIG. 1 in the assembled state;

FIG. 3 is an identical view to that of FIG. 2 of a second embodiment of a tubular joint according to the invention;

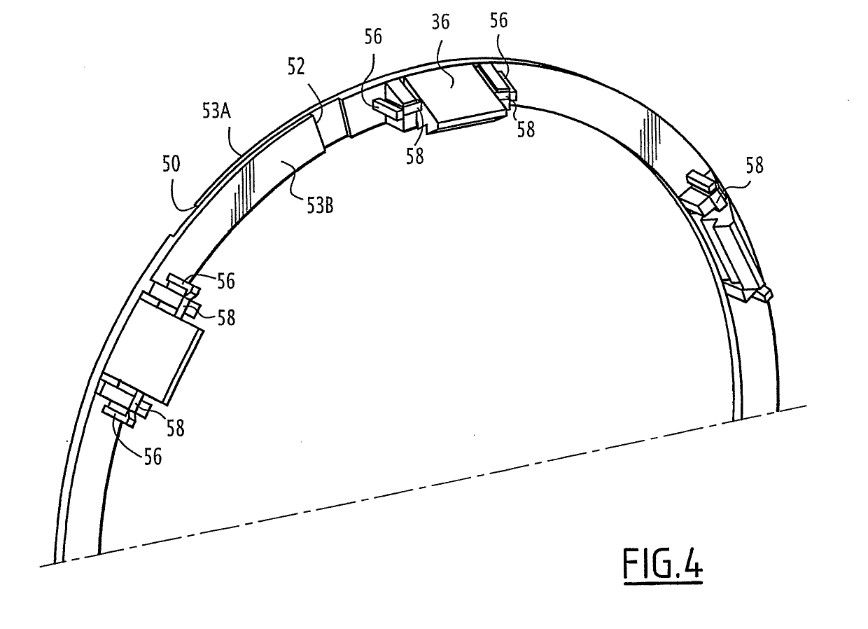

FIG. 4 is a perspective view of an anti-extrusion ring used in the tubular joint of FIG. 3;

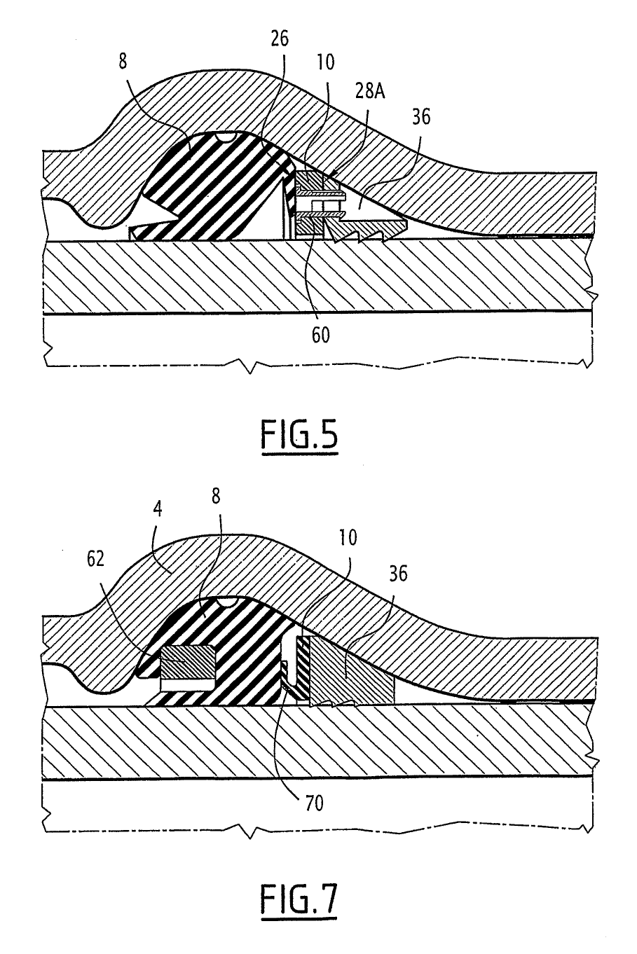

FIG. 5 is a view corresponding to that of FIG. 2 of a tubular joint according to a third embodiment of the invention;

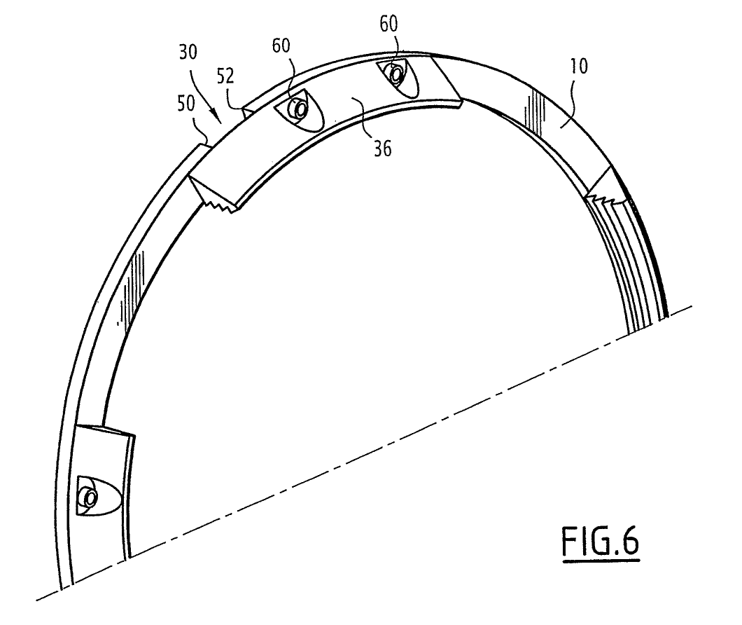

FIG. 6 is a perspective view of the anti-extrusion ring of the tubular joint of FIG. 5;

FIG. 7 shows a fourth embodiment of a tubular joint according to the invention, the view corresponding to that of FIG. 2; and

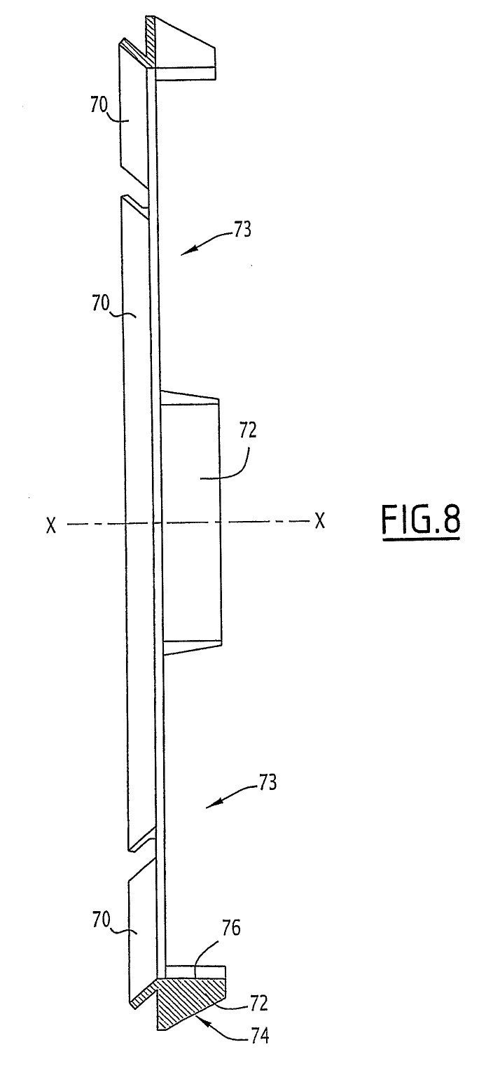

FIG. 8 shows a side view, in partial cross-section, of an anti-extrusion ring used in the tubular joint of FIG. 7.

FIG. 1 shows a tubular joint according to the invention, designated by the general reference numeral 2.

The tubular joint 2 comprises a first pipe element equipped with an interlocking tip 4, a second pipe element equipped with a smooth tip 6, a sealing liner 8, an anti-extrusion ring 10 and a split locking ring 12.

The tubular joint 2 defines a central axis X-X. In the text that follows, the expressions “axially”, “radially” and “circumferentially” will be used in relation to this central axis X-X.

The interlocking tip 4 comprises a fixing flange 14 for assembly with a pipe element (not illustrated) equipped with a corresponding flange, and a free end 16, turned towards the smooth tip 6. The interlocking tip 4 also comprises an annular inner groove 18 (see FIG. 2). In this particular case, the groove 18 has a cross-section that is substantially an arc of a circle, but it may have other forms, for example a rectangular cross-section.

As can be seen in FIG. 2, in the assembled state of the tubular joint, the sealing liner 8, the anti-extrusion ring 10 and the locking ring 12 are inserted in the inner groove 18 and the smooth tip 6 is inserted in the free end 16 of the interlocking tip. The sealing liner 8 is arranged axially on the side turned towards the fixing flange 14 and the locking ring 12 is arranged axially on the side of the free end 16, the anti-extrusion ring 10 being sandwiched between the sealing liner 8 and the locking ring 12.

The sealing liner 8 is manufactured in rubber for example. It comprises a base body 20, a sealing lip 22, and a thrust lip 24, extending radially inwards, and being applied on the anti-extrusion ring 10. The thrust lip 24 elastically stresses the anti-extrusion ring 10, axially against the locking ring 12.

The sealing lip 22 is applied radially against the smooth tip 6 when said smooth tip is introduced in the interlocking tip 4, and when pressure is applied, the sealing lip 22 is applied against the smooth tip 6 with increasing strength as the pressure of the fluid circulating in the pipe elements 4 and 6 rises. The tubular joint is therefore of the automatic type in that the seal is obtained automatically when the smooth tip 6 is introduced in the interlocking tip 6 by radial compression of the sealing liner 8 between the two pipe elements 4, 6.

The anti-extrusion ring 10 is a ring made for example of metal or a rigid plastic material, such as polyamide 6-6. The anti-extrusion ring 10 comprises a flat surface 26 turned towards the sealing liner 8, and a tapered surface 28 turned towards the locking ring 12. In addition, as can be seen in FIG. 1, the anti-extrusion ring 10 comprises a radially traversing slit 30 allowing assembly of the anti-extrusion ring 10 in the groove 18 by elastic deformation.

The locking ring 12 consists of two metal locking elements 36 in the form of segments of the arc of a circle, which are connected by a toric ring 38, made of rubber for example. In a variant, the locking ring comprises more than two locking elements 36.

The locking elements 36 comprise a row of teeth 40 turned radially inwards and being applied to the outer surface of the smooth tip 6 in the assembled state. Moreover, the locking elements 36 comprise an outer surface 42, inclined in relation to the axis X-X and being applied against the corresponding inclined surface of the inner groove 18 of the interlocking tip 4. Thus, the locking elements 36 oppose disassembly of the smooth tip 6 and the interlocking tip 4.

In this embodiment, the anti-extrusion ring 10 is placed freely on the sealing liner 8 and the locking ring 12 is placed freely on the anti-extrusion ring 10. The three components sealing liner 8, locking ring 12 and anti-extrusion ring 10 are thus not fixed to each other and can therefore be manufactured independently of each other.

When pressure is applied, the anti-extrusion ring 10 prevents the rubber of the sealing liner 8 from being extruded through the annular space delimited by the inner diameter of the interlocking tip 4 and the outer diameter of the smooth tip 6.

FIG. 3 illustrates a view in partial cross-section of a second embodiment of a tubular joint according to the invention.

This tubular joint differs from that of FIGS. 1 and 2 as follows.

The anti-extrusion ring 10 is an open ring having two circumferential ends 50, 52. These circumferential ends 50, 52 are formed by two circumferential portions 53A, 53B which have a small axial thickness compared with the rest of the anti-extrusion ring 10. Moreover, the circumferential portions 53A, 53B overlap circumferentially in the assembled state in the inner groove 18, in such a way that the axial projection of the anti-extrusion ring 10 is closed. Thus, the anti-extrusion ring 10 opposes extrusion of the elastic material of the sealing liner 8 particularly well and adapts well to different diameters of the interlocking tip and the smooth tip.

The anti-extrusion ring 10 is a ring that has parallel frontal radial surfaces 26, 28A on which the sealing liner 8 and the locking elements 36 respectively are applied.

Moreover, the locking elements 36 are fixed releasably to the anti-extrusion ring 10. Accordingly, the anti-extrusion ring 10 comprises latching projections 56 which cooperate by elastic interlocking with pins 58 integral with each locking element 36. Each locking element 36 is therefore fixed by complementarity of form to the anti-extrusion ring 10.

This embodiment is particularly easy to adapt to the different requirements of the tubular joint. In fact, when it is not necessary to make provision for a locked tubular joint, the locking elements 36 may be omitted, thus reducing the material used for the joint. When a locked tubular joint is necessary, the locking elements are clipped to the anti-extrusion ring 10.

Moreover, this embodiment reduces the manufacturing cost of the tubular joint given that the same anti-extrusion ring 10 may be manufactured for joints that are locked or not locked.

FIG. 5 shows a third embodiment of a tubular joint according to the invention, which differs from that of FIG. 3 as follows.

The circumferential portions of the ring 10 adjacent to the two circumferential ends 50, 52 do not overlap in the assembled state and are turned towards each other.

The locking elements 36 are fixed by rivets 60 to the anti-extrusion ring 10.

Moreover, the anti-extrusion ring 10 has a substantially uniform axial thickness over its entire extent, apart from holes receiving the rivets.

Thus, the ring 10 is particularly easy to manufacture.

In addition, as indicated in FIG. 6 and in order to increase the effectiveness of retention of the anti-extrusion ring 10, a portion of the locking element 36 overlaps completely the slit 30 created by the ends 52, 50 of the anti-extrusion ring, in such a way that the axial projection of the anti-extrusion ring 10 and of the locking elements 36 is closed.

This embodiment has the same advantages as that of FIGS. 3 and 4.

In FIG. 7 a fourth embodiment is shown of a tubular joint according to the invention.

Unlike the other embodiments mentioned above, a retention ring 62 is arranged in a recess of the sealing liner 8 which, in addition, does not comprise a thrust lip 24. This retention ring 62 is produced in a plastic material, such as polyethylene, nylon or polycarbonate, for example; it compresses the sealing liner 8 against the inner surface of the interlocking tip 4 and ensures the stability of the liner 8 in the groove 18.

Moreover, the anti-extrusion ring 10 is equipped with a thrust projection 70 designed to be applied against the sealing liner 8 and suitable for thrusting the anti-extrusion ring 10 axially away from the sealing liner 8. The thrust projection 70 has the form of a lip which is turned radially outwards, and which is fixed on a radially internal portion of the anti-extrusion ring 10.

Thus, at minimum play between the smooth tip 6 and the interlocking tip 4, this thrust projection 70 is folded elastically and therefore limits the space requirement in the annular groove 18 serving as housing for various sealing and locking components 8, 10, 12, thus offering an additional volume allowing the interlocking stress of the smooth tip 6 to be reduced. At maximum play between the smooth tip 6 and the interlocking tip 4, this lip 70 is folded and thrusts the locking elements 36 against the inner surface of the interlocking tip 4 prior to pressure being applied, thus limiting backward movement of the smooth tip when pressure is applied. At average play, the lip 70 aids engagement of the locking elements 36 when pressure is applied, thus minimising backward movement of the smooth tip 6.

In FIG. 8, a view in axial cross-section is shown of the anti-extrusion ring 10 before the locking elements 36 are put in place. In order to increase the effectiveness of the anti-extrusion ring 10, said anti-extrusion ring comprises anti-extrusion elements 72 which extend over a circumferential portion of the anti-extrusion ring 10, thus leaving interstices 73 between them serving as housing for the locking elements 36, said locking elements being fixed to the anti-extrusion ring by any appropriate means. The anti-extrusion elements 72 have the form of a ring segment and have an outer surface 74 in the form of a partial truncated cone which is turned in the assembled state towards the free end 16 of the interlocking tip 4. Moreover, each anti-extrusion element 72 comprises a partially cylindrical inner surface 76 of axis X-X. Advantageously, the anti-extrusion elements 72 have a profile substantially identical to that of the locking elements 36, the outer surface 74 therefore being flush with the outer surface of the locking elements 36.

In a variant, not illustrated, the anti-extrusion means, in other words the anti-extrusion ring 10 and/or the anti-extrusion elements 72 may be fixed to the sealing liner 8, thus facilitating handling of these components and therefore making assembly faster.

On this subject, it is particularly advantageous that the anti-extrusion means be manufactured in a single piece with the sealing liner, but in a material that is different from that of the sealing liner.

1. Tubular joint, of the type comprising
an interlocking tip (4) of a first pipe element, equipped with an inner groove (18) and suitable to receive a smooth tip (6) of a second pipe element and,
a sealing liner (8) arranged in the inner groove (18),
the tubular joint comprising anti-extrusion means (10, 72) adjacent to the sealing liner (8) and suitable for opposing extrusion of the sealing liner (8) when said liner is subjected to the pressure of a fluid circulating in the pipe elements,
characterised in that it comprises at least one locking element (36) arranged adjacent to the anti-extrusion means (10, 72), on the side opposite the sealing liner (8).

2. Tubular joint according to claim 1, characterised in that the anti-extrusion means comprise an anti-extrusion ring (10).

3. Tubular joint according to claim 2, characterised in that the anti-extrusion ring (10) is open and comprises two end portions (53A, 53B) which, in the assembled state in the inner groove (18), overlap circumferentially.

4. Tubular joint according to claim 2, characterised in that the anti-extrusion ring (10) is fixed to the sealing liner (8).

5. Tubular joint according to claim 2, characterised in that the anti-extrusion ring (10) is applied freely on the sealing liner (8).

6. Tubular joint according to claim 2, characterised in that the anti-extrusion means comprise at least two anti-extrusion elements (72) in the form of a ring segment.

7. Tubular joint according to claim 6, characterised in that the anti-extrusion elements (72) are integral with the anti-extrusion ring 10.

8. Tubular joint according to claim 2, characterised in that at least one locking element (36) is fixed to the anti-extrusion ring (10).

9. Tubular joint according to claim 8, characterised in that at least one of the locking elements (36) is fixed releasably to the anti-extrusion ring (10).

10. Tubular joint according to claim 9, characterised in that the locking element (36) is fixed by complementarity of form, in particular by latching, to the anti-extrusion ring (10).

11. Tubular joint according to claim 6, characterised in that the or each locking element (36) is inserted in an interstice (73) formed by the anti-extrusion elements (72), and in that the outer surfaces of at least one locking element (36) and at least one of the anti-extrusion elements (72) are flush.

12. Tubular joint according to claim 2, characterised in that the anti-extrusion ring (10) comprises thrust means (70) suitable for stressing the or each locking element (36) axially away from the sealing liner (8).

13. Tubular joint according to claim 12, characterised in that the thrust means comprise a thrust projection (70) integral with the anti-extrusion ring (10).

14. Tubular joint according to claim 2, characterised in that the sealing liner (8) comprises thrust means, in particular a flexible lip (24) integral with the sealing liner (8), suitable for stressing the or each locking element (36) axially away from the sealing liner (8).

15. Tubular joint according to claim 13, characterised in that the thrust means (70, 24) have a free end turned radially outwards or inwards.

16. Tubular joint according to claim 1, characterised in that it comprises a smooth tip (6) inserted in the interlocking tip (4), the sealing liner (8) being compressed radially between the smooth tip (6) and the interlocking tip (4).
